(19) United States
(12) Patent Application Publication
(10) Pub. No.: US 2018/0192135 A1
(43) Pub. Date: Jul. 5, 2018

(54) SYSTEM AND METHOD FOR DIGITAL TELEVISION OPERATION AND CONTROL - RECOMMENDATIONS

(71) Applicants: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(72) Inventors: Sanjiv SIRPAL, Oakville (CA); Mohammed SELIM, Oakville (CA); Alexander DePaz, Burlington (CA); Salvador SOTO, Toronto (CA); Saulo Correia DOURADO, Oakville (CA); Robert MacArthur, Milton (CA); Dean BRITTO, Mississauga (CA)

(73) Assignees: Jamdeo Canada Ltd., Oakville, ON (CA); Hisense Electric Co., Ltd., Qingdao (CN); Hisense USA CORP., Suwanee, GA (US); Hisense International Co., Ltd., Qingdao (CN)

(21) Appl. No.: 15/396,298

(22) Filed: Dec. 30, 2016

(51) Int. Cl. H04N 21/466; H04N 21/442; H04N 21/431

(52) U.S. Cl. CPC H04N 21/4667; H04N 21/44204; H04N 21/4668; H04N 21/4316; H04N 21/44222

(57) ABSTRACT

A method for controlling display device operation including: monitoring usage of a display device with respect to content selections of a control interface; presenting the control interface including: a primary display region having a first plurality of graphical elements selected based on content selections for a selected tab element, and a secondary display area including a plurality of horizontal navigation bars, the plurality of horizontal navigation bars being arranged in a listing order based on contextual relevance and including respective second pluralities of graphical elements; detecting a selection of a graphical element of the first and second pluralities of graphical elements; and updating, in response to the detecting, the presentation of the control interface by: updating the first plurality of graphical elements of the primary display region, and updating the listing order and second pluralities of graphical elements of the plurality of horizontal navigation bars.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for control interfaces for applications and television components. In particular, there exists a need for programs and configurations that allow for features of the applications to be presented, accessed and customized on a digital television. While execution of an application and application interfaces exist for digital televisions, there exists a need for improved control of television features. Conventional interfaces do not adapt to content being displayed on a television device. Moreover, conventional interfaces require complex menus with distracting elements and can require extraneous actions for use. There is a desire for contextualized navigation and updating to improve functionality and usability of display devices.

### SUMMARY

Disclosed and claimed herein are methods, devices and systems for control of a digital television. One embodiment is directed to a method of controlling display device operation including: monitoring, by the display device, usage of the display device with respect to content selections of a control interface of the display device; presenting, by the display device, the control interface, wherein the control interface includes: a primary display region including a first plurality of graphical elements selected based on content selections for a selected tab element, and a secondary display area including a plurality of horizontal navigation bars, the plurality of horizontal navigation bars being arranged in a listing order based on contextual relevance to the selected tab element, and the plurality of horizontal navigation bars including respective second pluralities of graphical elements; detecting, by the display device, a selection of a graphical element of the first and second pluralities of graphical elements; and updating, by the display device in response to the detecting, the presentation of the control interface by: updating the first plurality of graphical elements of the primary display region, and updating the listing order and second pluralities of graphical elements of the plurality of horizontal navigation bars.

The monitoring usage of the display device may include: identifying titles of content accessed by a user using the control interface; identifying categories of content associated with accessed content titles; and monitoring a presentation time of the accessed content.

The monitoring usage of the display device may include: monitoring media content accessed using the display device; monitoring games played using the display device; and monitoring third-party applications accessed using the display device.

The first plurality of graphical elements may correspond to respective content accessible by the display device. The method may further include selecting the first plurality of graphical elements such that the respective content relates to a current content most recently presented by the display device.

The listing order of the plurality of horizontal navigation bars may be selected such that the second plurality of graphical elements in higher horizontal navigation bars are more contextually related to a current usage of the display device.

The contextual relevance of a navigation bar from the plurality of navigation bars include at least one selected from the group of contextual content, usage-based content, user preference content, social media driven content, and curated content. Contextual content may be more contextually relevant than usage-based content, which is more contextually relevant that user preference content. User preference content may be more contextually relevant than social media driven content, which is more contextually relevant than curated content.

The detecting may include: detecting navigation within the secondary display area; and detecting a selection of a graphical element from among the respective second pluralities of graphical elements.

The updating the presentation of the control interface may include updating a current content presented by the display device to a content corresponding to the selected graphical element.

The updating the presentation of the control interface may further include changing a category type for populating each of the plurality of horizontal navigation bars.

The method may further include creating, by the display device, tables for content tiles and tile elements based on monitored usage and content available to the display device.

According to some embodiments, there is provided a display device including: a display; a memory; and a processor coupled to the memory and the display. The processor may be configured to: monitor usage of the display device with respect to content selections of a control interface of the display device; present, on the display, the control interface, wherein the control interface includes: a primary display region including a first plurality of graphical elements selected based on content selections for a selected tab element, and a secondary display area including a plurality of horizontal navigation bars, the plurality of horizontal navigation bars being arranged in a listing order based on contextual relevance to the selected tab element, and the plurality of horizontal navigation bars including respective second pluralities of graphical elements; detect a selection of a graphical element of the first and second pluralities of graphical elements; and update, in response to the detecting the selection, the presentation of the control interface by: updating the first plurality of graphical elements of the primary display region, and updating the listing order and second pluralities of graphical elements of the plurality of horizontal navigation bars.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a control interface of a display device according to one or more embodiments.

FIG. 2 depicts a simplified system diagram according to one or more embodiments.

FIG. 3 is a flowchart illustrating a method of controlling a display device according to an example embodiment.

FIG. 4 is a flowchart illustrating monitoring a display device according to an example embodiment.

FIG. 5 is a flowchart illustrating updating a control interface according to an example embodiment.

FIG. 6 is a block diagram of an illustrative computer system architecture according to an example implementation.

FIG. 7 depicts a graphical representation of digital television operation according to one or more example embodiments.

FIG. 8 depicts a graphical representation of a control interface operation according to one or more example embodiments.

FIG. 9 illustrates a recommendation spectrum according to an example embodiment.

### DETAILED DESCRIPTION OF THE EXAMPLE EMBODIMENTS

One aspect of the disclosure relates to providing a control interface for a digital television. In one embodiment, a system and framework are provided for presentation of a control interface. The control interface may include a primary display area and a secondary display area. The secondary display area may include a plurality of horizontal navigation bars arranged by contextual relevance. The primary display area and the secondary display area may include a plurality of graphical elements corresponding to content. The selection of the graphical elements and the order and selection of the horizontal navigation bars may be based on monitored usage of a display device and a current usage of the display device.

Example implementations of the disclosed technology will now be described with reference to the accompanying figures.

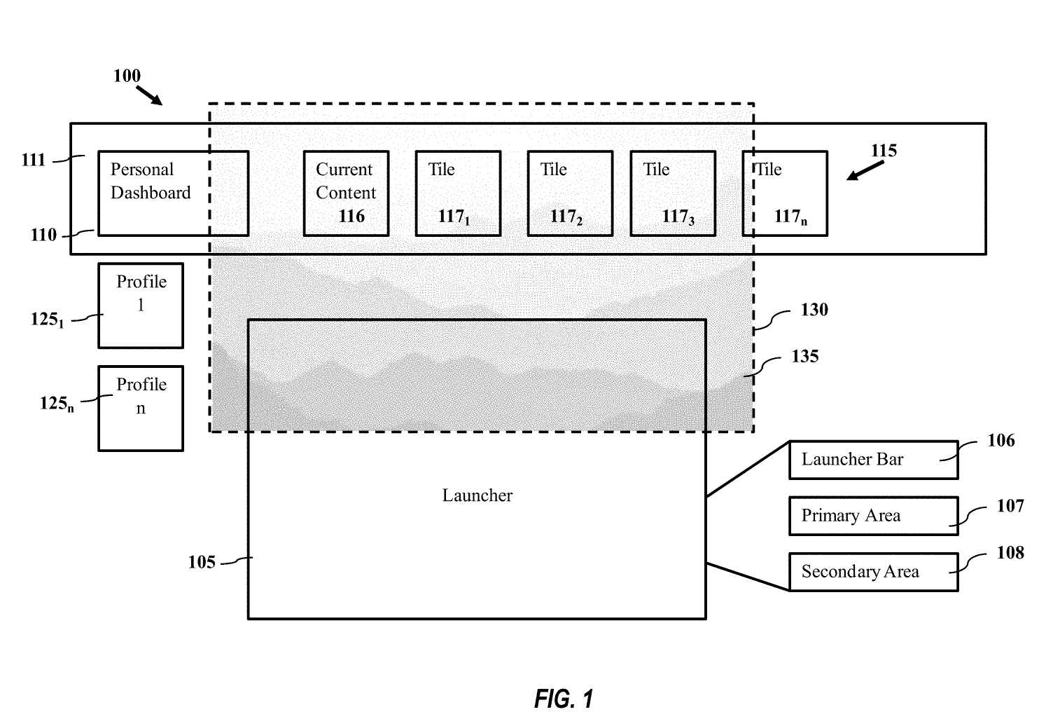

Referring now to the figures, FIG. 1 depicts a graphical representation of a control interface of a display device according to one or more embodiments. According to one embodiment, control interface 100 relates to a graphical user interface presented to control a display device, such as a digital television. According to one aspect of the disclosure, control interface 100 includes a plurality of components that each provide a plurality of functions and features for control and operation of a display device. In addition to providing separate components for particular interaction, control interface may also be configured to operate with a specific arrangement. According to one embodiment, presentation of each component of control interface 100 is presented based on a spatial arrangement model. According to one embodiment, the spatial arrangement model defines a relative position of components of control interface 100 to allow for directional navigation of the interface. By employing a spatial arrangement model, components of the control interface 100 allow for many features of the display device to be easily accessed and controlled. In addition to facilitating access, the spatial arrangement model provides a specific formatting to each view of control interface to emphasize elements for control.

According to one embodiment, components of control interface 100 include launcher component 105, dashboard component (e.g., personal dashboard) 110 and activity strip 115. According to another embodiment, a spatial arrangement model defines the location of each component of control interface 100 relative to a display screen. In an exemplary embodiment, launcher component 105 is oriented relative to a bottom portion of the display, dashboard component (e.g., personal dashboard) 110 is oriented relative to a left side of the display, and activity strip 115 is oriented relative a right side of the display. According to another embodiment, the display format of each component is defined by the spatial arrangement model such that each component may have an initial presentation characterized by a particular format, size, functionalities displayed, etc. Based on navigation commands relative to the control interface, the display device may update and rearrange the position and display format for each component of control interface 100.

Control interface 100 is shown in FIG. 1 relative to a display 130 and display content 135. According to one embodiment, the display format of control interface 100 can include presentation of some or all components of the control interface on display 130. Based on commands detected during presentation of the control interface 100, a display device may update the presentation format and elements of control interface 100 on display 130.

According to one embodiment, control interface 100 provides a mechanism for accessing multiple components of a display device. While the description of FIG. 1 discusses three components of control interface 100 (launcher component 105, dashboard component 110 and activity strip 115), it should be appreciated that additional components may be added to or included with control interface 100. As will be discussed herein, control interface 120 may be employed to control operation of digital television.

Activity bar includes plurality of tile elements 116 and 117₁₋ₙ. According to one embodiment, presentation of control interface 100 may be presented as an overlay to content 135 presented on display 130. The display device may freeze or continue presenting the display output of content 135 in a tile element 116 in activity bar 115. In certain embodiments, navigation away from current content tile 116 will pause or stop playback. Current content tile 116 allows for selection of the previously displayed content to return to presentation of the display. Current content tile 116 is presented based on the content displayed by the display device prior to display of control interface 100. Tile elements 117₁₋ₙ relate to activity feed based on current content. In one embodiment, tile elements 117₁₋ₙ relate to a single type of content, such as broadcast TV shows related current content 116 and/or based on viewing habits of an active profile. According to another embodiment, tile elements 117₁₋ₙ may be a mix of content types, such as broadcast content, video on demand, applications, etc. In one embodiment, a display device may curate content and features to be included with activity bar as tile elements 117₁₋ₙ and present activity bar as a horizontal deck of elements in horizontal region 111. Horizontal region 111 allows for left and right directional commands to navigate to and within components of control interface 110.

Profiles 125₁₋ₙ relate to one user profiles stored by a display device for control interface 100. In one embodiment, profiles 125₁₋ₙ are utilized to determining display format of the personal dashboard component 110. According to another embodiment, one or more elements of launcher component 105 and activity strip 115 may be presented base on an active profile of profiles 125₁₋ₙ. When a profile has not been selected, an active profile may be the last selected or utilized user profile.

According to another embodiment, components of control interface 100 may be selected, navigated and updated based on user interactions with a display device and one or more inputs from a remote control. According to one embodiment, elements of control interface 100 are presented by display device 130, such as digital television, as part of control interface 120.

Presentation of control interface 100 may be in response to a command from remote control, such as selection of a home or menu key. According to another embodiment, control interface 100 may be displayed shortly after a power on of display device 130. According to another embodiment control interface 100 may be presented following presentation of a wake animation and prior to display of a sleep or shutdown animation.

From control interface 100, several features and functions of a display device may be provided by ordered combinations of display device operation and graphical elements presented by the display device.

Launcher

According to one embodiment, launcher component 105 is configured to allow for a user to access content and control features of the display device. In one embodiment, launcher component includes a launcher bar 106, primary area 107 and secondary area 108. Launcher bar 106 may related to a plurality of tab elements arranged in a horizontal strip, wherein selection by moving a highlight element of the display device to a tab element will update the presentation elements of the launcher. By way of example, launcher bar 105 may include a tab for broadcast channels, video on demand and display device settings. Primary area 107 may include presentation of tile elements below the launcher bar 106. Tile elements of primary area 107 may be selected by the display device as the most relevant content of features associated with a selected tab element. Secondary area 108 may be presented below the primary area with additional tiles associated with content and/or display device function. Secondary area 108 may allow for additional selectable elements. According to one embodiment, the display format of launcher bar 106, primary area 107, and secondary area 108 may be based on the presentation status of the control interface. For example, launcher component may be presented initially with launcher bar 106, then commands to expand launcher component (e.g., a directional command) can result in display device updating the display output to include one or more tile elements of the primary area. Tile elements of the secondary area 108 may be presented based on additional navigation within the launcher component.

According to one embodiment, an initial format, such as a home screen presentation, of control interface 100 includes presentation of launcher bar, and a row of tile elements of the primary area. Based on a user input to select and/or navigate within launcher component 105, additional formats may be presented such as an increase in presentation footprint of the launcher to allow for secondary area 108 to include additional rows of tile elements. According to another embodiment, the primary area 107 and secondary area 108 of launcher component 105 may also include a first section for presentation of a most relevant tile element, and a second section for presentation of other tile elements along a horizontal display plane.

According to one embodiment, control interface 100 provides launcher component 105 as an overlay control interface to allow for presentation of content and control features based on selection of launcher tabs and navigation within the launcher component. In one embodiment, the configuration of launcher component 105 is a progression away from traditional desktop menus and allows for simple directional commands to access TV, network, applications, recommendations, personalized configurations, and recent content. According to another embodiment, launcher bar 106 of launcher component 105 includes a plurality of tab or tile elements, wherein each tab allows for a selection of a particular type of content, source of content, and/or control features of a display device. Based on the selection of a tab element of launch bar 106, launcher component may present multiple rows of content/element tiles and allows for scrolling to additional rows within a display window to provide and extended content region. In one embodiment, each row of content tiles may be navigated to based on vertical directional commands (e.g., up/down) and rows of content tiles may be navigated with horizontal directional commands (e.g., left/right). The presentation order of rows and even tiles in each row may be based on one or more of a selected user profile, content presented prior to display of control interface 100 and relevance determinations. In additional to content, such as video and programming information, tiles presented in launcher component 105 may relate to one or more of applications, settings, smart home applications, education/learning applications, gaming, etc.

Launcher Search

According to one embodiment, control interface 100 may include a search functionality component including a graphical interface for searching content titles, applications and elements of launcher component 105. In one embodiment, the search functionality may be presented as a drop down (e.g., down sliding transition) interface from an intermediary presentation format of control interface 100. According to another embodiment, the search functionality can interact with other devices (e.g., mobile devices) with a display device hosting a network interface for entry of search queries. Features of the search functionality can include one or more of a text entry box, alpha numeric display, recent search listing and suggested search results.

Personal Dashboard

According to one embodiment, control interface 100 includes dashboard component 110 to provide a user customizable control interface for a portion of the control features. In one embodiment, dashboard component 110 provides graphical elements for selecting and modifying display attributes and functionality of the dashboard. According to another embodiment, dashboard component can allow for a graphical selection of user profiles that can define features of control interface 100.

According to one embodiment, personal dashboard component 110 allows for presentation of a personalized control interface associated with a user profile. By way of example, display device is configured to allow a user to personalize the display format of the user interface to select display attributes such as a wallpaper, avatar, etc. In that fashion, dashboard component 110 allows for presentation of a personalized control interface. According to one embodiment, control interface 100 can allow for presentation of several user profiles 125₁₋ₙ. Selection of the profile may be performed during navigation to personal dashboard component 110 within control interface 100. According to one embodiment, the initial display presentation format of personal dashboard component 110 relates to a tile element, such as a screen capture of the personal dashboard. When an intermediate display configuration of control interface 100 is provided, the same tile representing personal dashboard component 110 may be reformatted. According to one embodiment, personal dashboard component 110 may be displayed adjacent to activity bar 115 in a horizontal region 111 of the display.

In one embodiment, dashboard component 110 provides a display interface to include notifications and access to applications which may be run by a display device. According to another embodiment, dashboard component 110 allows for personalization such as one or more of wake/sleep animations, screensavers, audio themes, badges and gaming. Dashboard component 110 allows for a customizable interface within the overall control interface 100 of a display device.

Touch Interface

Presentation of elements within control interface can include one or more display formats and format changes. In certain embodiments, presentation of elements introduces similarities of touch commands to a display device operated from a distance without actual contact to the display. According to one embodiment, control interface 100 can update presentation of display elements such as tiles to gradually reveal content. According to one embodiment, control interface 100 can receive inputs based on a capacitive touch sensor with gradual display of elements, but also allowing for accidental touches. Capacitive interaction can provide a control feature with a level of touch control for a display device that is normally operated/viewed from a distance. Control interface 100 may be configured with an interaction to model tactile representation for interaction with elements based on a capacitive/interactive remote control. In one embodiment, interaction may include progressive disclosure of content, a multilayered preview into content and instant access to recommendation.

Contextual Touch

According to one embodiment, elements of control interface 100 can support presentation of tile elements as overlay to content without presentation of the full control interface. By way of example, a display device may be configured to recognize a category or genre of actively displayed content and present a display of similar programs to avoid the need to access a display menu and searching of content.

Instant Companion Application and Search

According to one embodiment, control interface 100 can allow for control of a display device by a mobile device and to allow for presentation of graphical display elements of control interface 100 to be displayed by a mobile device. In one embodiment, control interface 100 may host temporary access between a display device and another web enabled device. According to another embodiment, devices may be paired based on displayed elements that may be detected by the web enabled device. Thus, control interface 100 may be configured for pairing/connection with a user interface, such as a personalized user dashboard for display devices and search functions within the launcher control interface. According to certain embodiments, interaction of a mobile device with control 100 does not require a user to download a specific application to establishing the temporary network connection for interaction and control of a display device.

Smart Sense Recommendations

According to one embodiment, control interface 100 can utilize one or more processes for populating content elements within launcher component 105. According to one embodiment, control interface 100 may be presented based on processes for tracking and identifying content for recommendation within the launcher component. For example, content tiles may be arranged in groupings such that groupings with the highest contextual relevance priority are arranged towards the top of launcher component 105.

Conversense

According to one embodiment, control interface 100 and elements of control interface 100 can be utilized by a display device to present a display configured tailored to startup of the display device with information and display elements having high relevance. In one embodiment, elements of the startup display may be selected and presented based on a recognized time of day, personal settings and history.

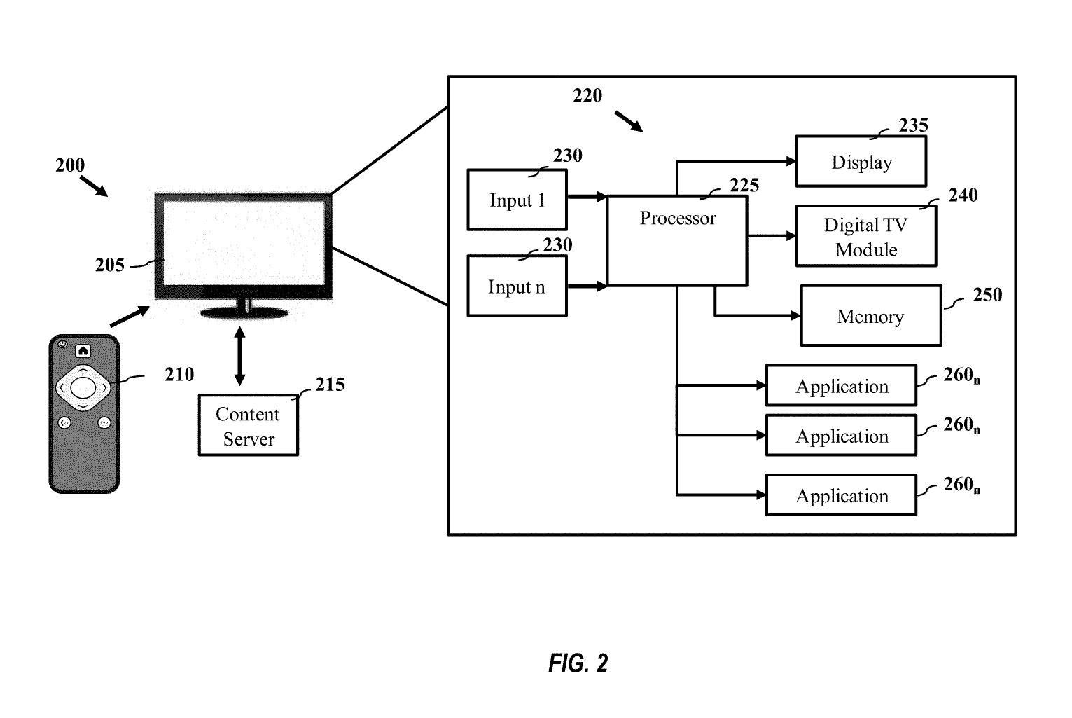

FIG. 2 depicts a simplified system diagram according to one or more embodiments. System 200 includes display device 205 and remote control 210. Remote control 210 may be configured to provide commands for interaction with and control of display device 205 relative to a control interface (e.g., control interface 100) presented by display device 205. Content, applications and other network services may be provided to display device 205 by way of one or more content servers, such as content server 215.

Digital television 200 includes processor 225, inputs 230, display 235, digital TV module 240, memory 250, and applications 260₁₋ₙ. It should be appreciated that digital television 205 may include one or more additional components not shown in FIG. 2. Digital television 205 is configured to present a control interface as described herein.

Inputs 230 relate to physical inputs for receiving video/image content and/or network data for presentation of content on display 235. Digital TV module 240 includes decoder/converter elements to receive information and content from inputs 230 which is then formatted and output to processor 225 for presentation on display 235. Memory 250 may include ROM and RAM memory for operation of digital television 205 and processor 225.

Processor 225, in addition to controlling operation of a digital television, is configured to control presentation and operation of a control interface. According to one embodiment, processor 225 is configured to detect commands for presentation of a control interface for the digital television, present the control interface including an expanded tab element and a plurality of tab elements. Processor 225 may also detect second or additional commands for the control interface to select one of the plurality of tab elements and update presentation of the control interface in response to the commands.

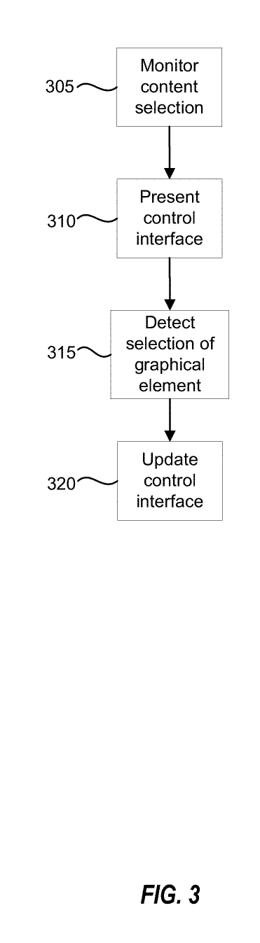

FIG. 3 illustrates a method of controlling a display device according to an example embodiment. The display device may be, as non-limiting examples, a television, such as a smart television, a projector, or a computer. In some cases, the method may be performed by a set-top box connected to a display device. The display device monitors selection of content on the display device at block 305. The content may be selected through a control interface of the display device, such a graphical user interface. According to some embodiments, at block 305 the display device may monitor media content accessed using the display device, games played using the display device, and third-party applications access using the display device.

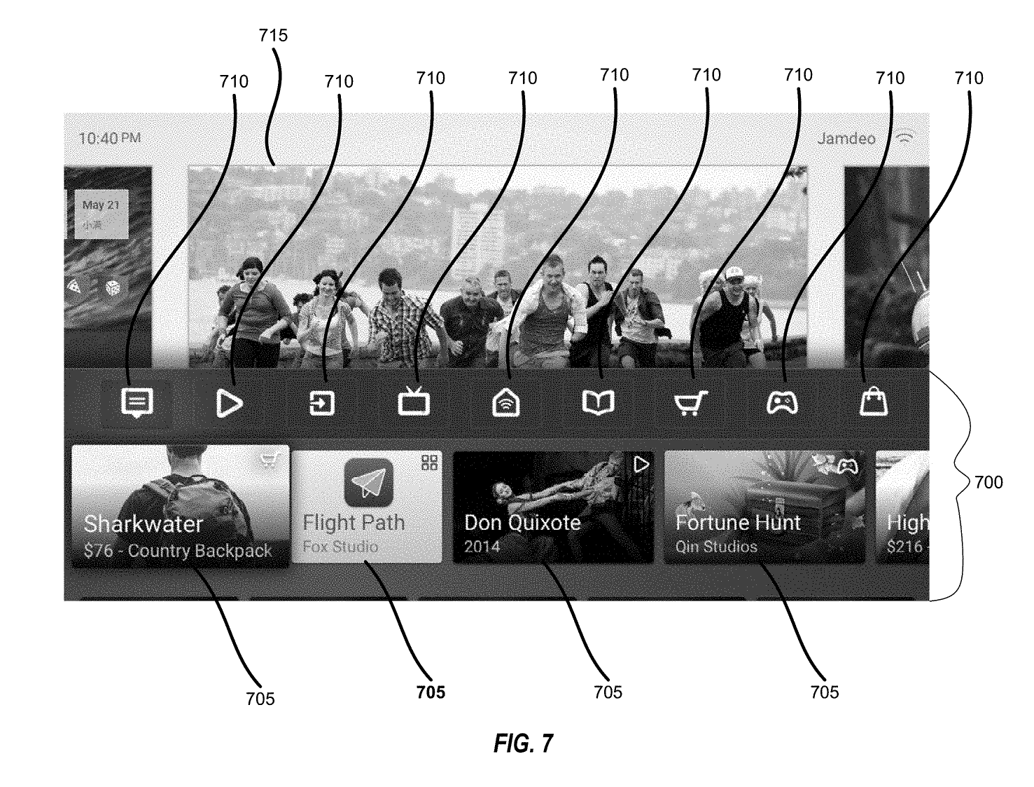

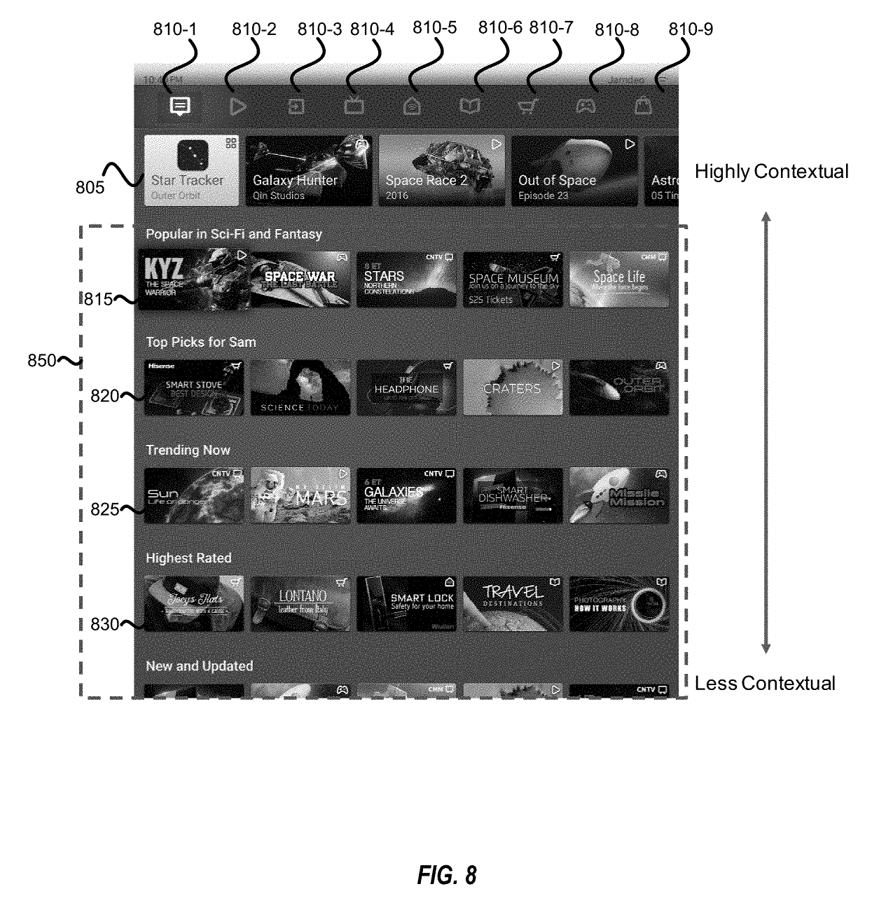

The display device presents the control interface including a plurality of graphical tab elements at block 310. The control interface may have a primary display region including a first plurality of graphical elements and a secondary display region including a plurality of horizontal navigation bars. The display device may select the first plurality of graphical elements that correspond to respective content related to a content currently presented by the display device. The navigation bars may be arranged in a listing order, and the navigation bars may include respective second pluralities of graphical elements. At block 310 the display device may present the control interface in response to, for example, a user input or an ending of a content being played on the display device. Example embodiments of the control interface will be discussed with more detail below with reference to FIGS. 7 and 8. According to some embodiments, the display device may create tables for graphical elements based on the monitored usage, available content, and a current displayed content.

The display device detects a selection of a graphical element from the plurality of first and second pluralities of graphical elements at block 315. The display device may receive a navigation instruction from a user, and may navigate through the primary or secondary display region to a graphical element before detecting the selection at block 315.

The display device updates the control interface in response to the detecting at block 320. In some examples, the updating may include changing category types for populating one or more of the horizontal navigation bars.

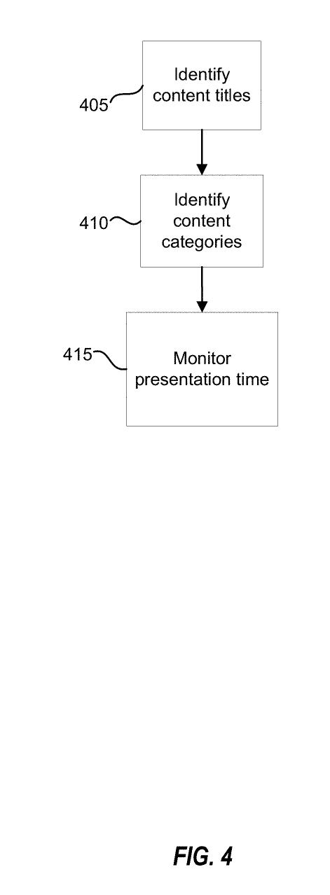

FIG. 4 is a flowchart describing the monitoring at block 305 in more detail according to an example embodiment. Referring to FIG. 4, the display device may identify titles of content selected on the display device at block 405. The display device may further identify a category of the content at block 410. For example, the display device may identify whether the content is, as non-limiting examples, a movie, a game, a television show, an application, etc. The display device may monitor a presentation time of the content, i.e., a length of time the content is displayed on the display device at block 415.

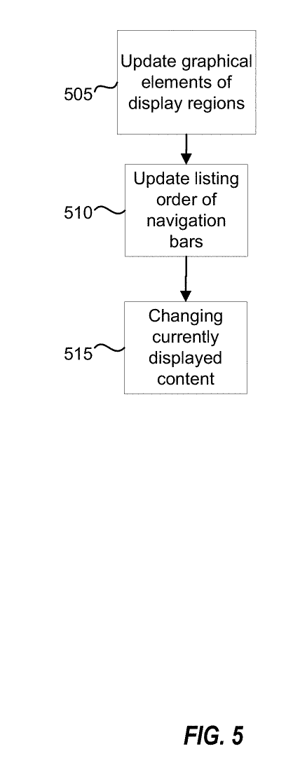

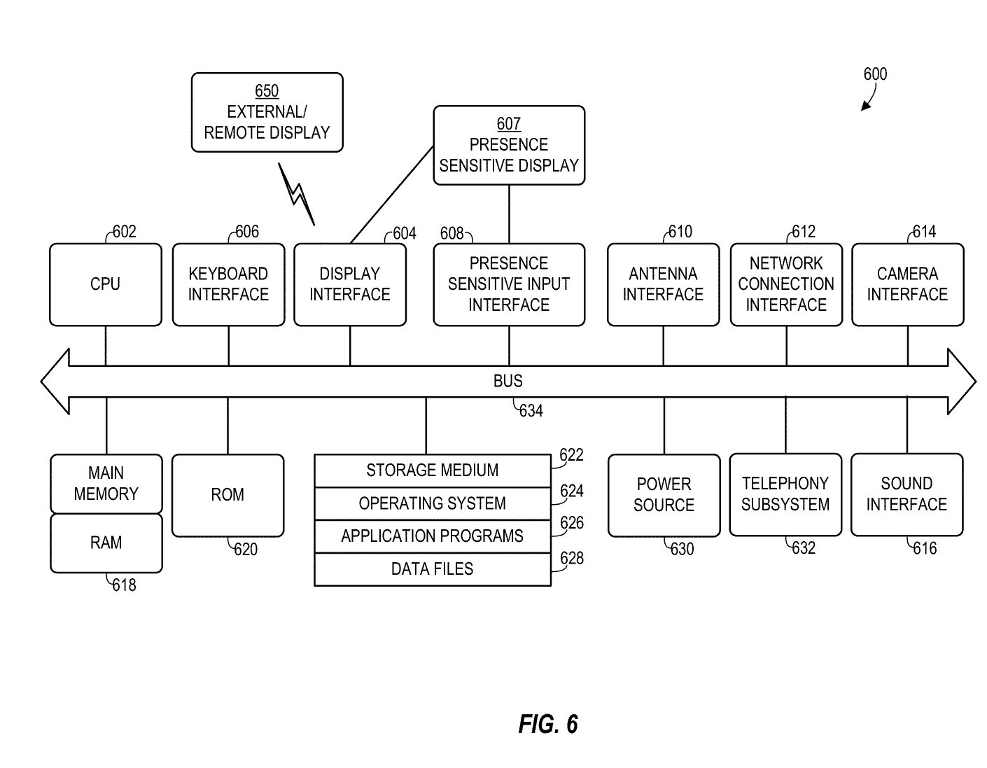

Referring to FIG. 5, updating the control interface at block 320 may include updating the graphical elements of the primary and secondary display regions at block 505, and updating 510 the listing order of the navigation bars at block 510. According to some embodiments, the updating at block 320 may further include changing a content currently displayed by the display device to a content corresponding to the selected graphical element at block 515. FIG. 6 is a block diagram of an illustrative computer system architecture 600, according to an example implementation. According to some embodiments, a display device may be implemented using one or more elements from the computer system architecture 600. It will be understood that the computing device architecture 600 is provided for example purposes only and does not limit the scope of the various implementations of the present disclosed systems, methods, and computer-readable mediums.

The computing device architecture 600 of FIG. 6 includes a central processing unit (CPU) 602, where computer instructions are processed, and a display interface 604 that acts as a communication interface and provides functions for rendering video, graphics, images, and texts on the display. In certain example implementations of the disclosed technology, the display interface 604 may be directly connected to a local display, such as a touch-screen display associated with a mobile computing device. In another example implementation, the display interface 604 may be configured for providing data, images, and other information for an external/remote display 650 that is not necessarily physically connected to the mobile computing device. For example, a desktop monitor may be used for mirroring graphics and other information that is presented on a mobile computing device. In certain example implementations, the display interface 604 may wirelessly communicate, for example, via a Wi-Fi channel or other available network connection interface 612 to the external/remote display 650.

In an example implementation, the network connection interface 612 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 604 may be operatively coupled to a local display, such as a touch-screen display associated with a mobile device. In another example, the display interface 604 may be configured to provide video, graphics, images, text, other information, or any combination thereof for an external/remote display 650 that is not necessarily connected to the mobile computing device. In one example, a desktop monitor may be used for mirroring or extending graphical information that may be presented on a mobile device. In another example, the display interface 604 may wirelessly communicate, for example, via the network connection interface 612 such as a Wi-Fi transceiver to the external/remote display 650.

The computing device architecture 600 may include a keyboard interface 606 that provides a communication interface to a keyboard. In one example implementation, the computing device architecture 600 may include a presence-sensitive display interface 608 for connecting to a presence-sensitive display 607. According to certain example implementations of the disclosed technology, the presence-sensitive display interface 608 may provide a communication interface to various devices such as a pointing device, a touch screen, a depth camera, etc. which may or may not be associated with a display.

The computing device architecture 600 may be configured to use an input device via one or more of input/output interfaces (for example, the keyboard interface 606, the display interface 604, the presence sensitive display interface 608, network connection interface 612, camera interface 614, sound interface 616, etc.) to allow a user to capture information into the computing device architecture 600. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 600 or may be a separate device. For example, the input device may be an accelerometer, a magnetometer, a digital camera, a microphone, and an optical sensor.

Example implementations of the computing device architecture 600 may include an antenna interface 610 that provides a communication interface to an antenna; a network connection interface 612 that provides a communication interface to a network. As mentioned above, the display interface 604 may be in communication with the network connection interface 612, for example, to provide information for display on a remote display that is not directly connected or attached to the system. In certain implementations, a camera interface 614 is provided that acts as a communication interface and provides functions for capturing digital images from a camera. In certain implementations, a sound interface 616 is provided as a communication interface for converting sound into electrical signals using a microphone and for converting electrical signals into sound using a speaker. According to example implementations, a random access memory (RAM) 618 is provided, where computer instructions and data may be stored in a volatile memory device for processing by the CPU 602.

According to an example implementation, the computing device architecture 600 includes a read-only memory (ROM) 620 where invariant low-level system code or data for basic system functions such as basic input and output (I/O), startup, or reception of keystrokes from a keyboard are stored in a non-volatile memory device. According to an example implementation, the computing device architecture 600 includes a storage medium 622 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, a widget or gadget engine, and or other applications, as necessary) and data files 628 are stored. According to an example implementation, the computing device architecture 600 includes a power source 630 that provides an appropriate alternating current (AC) or direct current (DC) to power components.

According to an example implementation, the computing device architecture 600 includes a telephony subsystem 632 that allows the device 600 to transmit and receive sound over a telephone network. The constituent devices and the CPU 602 communicate with each other over a bus 634.

According to an example implementation, the CPU 602 has appropriate structure to be a computer processor. In one arrangement, the CPU 602 may include more than one processing unit. The RAM 618 interfaces with the computer bus 634 to provide quick RAM storage to the CPU 602 during the execution of software programs such as the operating system application programs, and device drivers. More specifically, the CPU 602 loads computer-executable process steps from the storage medium 622 or other media into a field of the RAM 618 in order to execute software programs. Data may be stored in the RAM 618, where the data may be accessed by the computer CPU 602 during execution.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 622, which may include a machine-readable storage medium.

According to one example implementation, the term computing device, as used herein, may be a CPU, or conceptualized as a CPU (for example, the CPU 602 of FIG. 6). In this example implementation, the computing device (CPU) may be coupled, connected, and/or in communication with one or more peripheral devices, such as a display. In another example implementation, the term computing device, as used herein, may refer to a mobile computing device such as a Smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device or a display device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, the computer program code may control the computing device to implement a control method as discussed herein.

Referring to FIG. 7, FIG. 7 illustrates a control interface 700 according to an example embodiment. The control interface 700 includes a plurality of graphical elements 705. The graphical elements 705 correspond to different contents that may be selected on the display device. The graphical elements 705 may be arranged according to tabs 710. The tabs 710 may navigable and selectable by the display device. Selecting a different tab 710 may change the graphical elements 705. A first row of selectable graphical elements 705, e.g., a primary display area, may be key action titles arranged based on a current usage or the monitored usage. For example, if the monitoring indicates that a user watches a particular show or plays a particular game frequently or regularly, graphical elements 705 corresponding to the particular show or the particular game may be placed in the first row. The control interface 700 may be presented overlapping a current content 715 being displayed on the display device.

FIG. 8 illustrates an additional view of a control interface according to an example embodiment. The control interface includes a first row of graphical elements 805, e.g., a primary display area, a plurality of horizontal navigation bars 815-830, e.g., a secondary display area 850, and a plurality of tabs 810-1 through 810-9. The graphical elements of the primary and secondary display areas 805 and 850 may change based on a selected tab 810-1. The horizontal navigation bars 815-830 may be in an ordered list. The ordered list may depend on a selected tab.

According to some embodiments, each horizontal navigation bar 815-830 may include a plurality of graphical elements corresponding to a particular category, for example to a particular recommendation spectrum. The recommendation spectrum may be based upon different sources for selecting content to be represented by graphical elements in the primary and secondary display area.

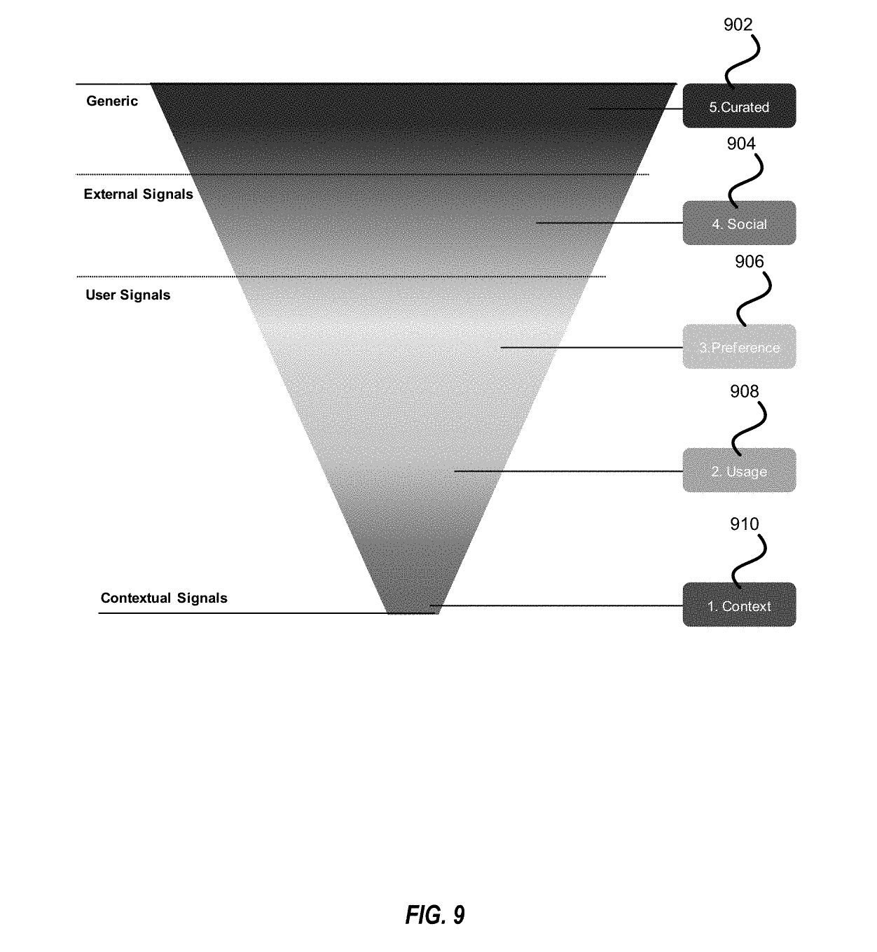

FIG. 9 illustrates a recommendation spectrum according to an example embodiment. As shown in FIG. 9, categories of the recommendation spectrum include curated content 902, social media driven content 904, user preference content 906, usage-based content 908, and contextual content 910.

Curated content 902 may be based on recommendations from a third-party, for example a content management system (e.g., horizontal bar 830 of FIG. 8). The curated content 902 may be uniform for all users, or may be customized for one or more users based on the third-party. Social media driven content 904 may be determined by evaluating external signals such as social media, news stories, current events, etc. The social media driven content 904 (horizontal bar 825 of FIG. 8) may be based on the media habits of a particular user of the display device.

User preference content 906 includes recommendations that are based on a user's explicit preference, e.g., a user's previous ratings or requests. Usage-based content 908 is derived from an implied usage of the system, e.g., viewing habits. For example, when and for how long a user watches different content types, genres, and titles, may drive the usage-based content 908. Contextual content 910 is based around a single piece content, for example, a content currently displayed on the display device (e.g., horizontal bar 815 of FIG. 8).

In some embodiments, the selection of graphical elements in some horizontal bars 815-830 may be based one or more categories of the recommendation spectrum (e.g., horizontal bar 820 of FIG. 8).

According to some embodiments, the ordered listing of the horizontal navigation bars 815-830 may be based on the contextual relevance of content included in the respective horizontal navigation bars 815-830. For example, a horizontal navigation bar 815 having a highest contextual relevance may be closest to the primary display area. For example, contextual content 910 may be included in the first row 805, and usage-based content 908 may be included in a top navigation bar 815.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims and their equivalents. Although specific terms are employed herein, they are used in a generic and descriptive sense only and not for purposes of limitation.

In the foregoing description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementation,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms should be construed to take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a -given sequence, either temporally, spatially, in ranking, or in any other manner.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims and their equivalents, and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

1. A method for controlling display device operation, the method comprising:
monitoring, by the display device, usage of the display device with respect to content selections of a control interface of the display device;
presenting, by the display device, the control interface, wherein the control interface includes:
a primary display region including a first plurality of graphical elements selected based on content selections for a selected tab element, and
a secondary display area including a plurality of horizontal navigation bars, the plurality of horizontal navigation bars being arranged in a listing order based on contextual relevance to the selected tab element, and the plurality of horizontal navigation bars including a second plurality of graphical elements;
detecting, by the display device, a selection of a graphical element of the first and second pluralities of graphical elements; and
updating, by the display device in response to the selection, the presentation of the control interface by:
updating the first plurality of graphical elements of the primary display region, and
updating the listing order and the second plurality of graphical elements of the plurality of horizontal navigation bars.

2. The method of claim 1, wherein the monitoring usage of the display device includes:
identifying titles of content accessed by a user using the control interface;
identifying categories of content associated with accessed content titles; and
monitoring a presentation time of the accessed content.

3. The method of claim 1, wherein the monitoring usage of the display device includes:
monitoring media content accessed using the display device;
monitoring games played using the display device; and
monitoring third-party applications accessed using the display device.

4. The method of claim 1, wherein
the first plurality of graphical elements correspond to respective content accessible by the display device, and
the method further comprises selecting the first plurality of graphical elements such that the respective content relates to a current content most recently presented by the display device.

5. The method of claim 1, wherein the listing order of the plurality of horizontal navigation bars is selected such that the second plurality of graphical elements in higher horizontal navigation bars are more contextually related to a current usage of the display device.

6. The method of claim 1, wherein
the contextual relevance of a navigation bar from the plurality of navigation bars include at least one selected from the group of contextual content, usage-based content, user preference content, social media driven content, and curated content,
contextual content is more contextually relevant than usage-based content, which is more contextually relevant that user preference content, and
user preference content is more contextually relevant than social media driven content, which is more contextually relevant than curated content.

7. The method of claim 1, wherein the detecting includes:
detecting navigation within the secondary display area; and
detecting a selection of a graphical element from among the respective second plurality of graphical elements.

8. The method of claim 1, wherein the updating the presentation of the control interface includes updating a current content presented by the display device to a content corresponding to the selected graphical element.

9. The method of claim 1, wherein the updating the presentation of the control interface includes changing a category type for populating each of the plurality of horizontal navigation bars.

10. The method of claim 1, further comprising creating, by the display device, tables for content tiles and tile elements based on monitored usage and content available to the display device.

11. A display device comprising:
a display;
a memory; and
a processor coupled to the memory and the display, the processor configured to:
monitor usage of the display device with respect to content selections of a control interface of the display device;
present, on the display, the control interface, wherein the control interface includes:
a primary display region including a first plurality of graphical elements selected based on content selections for a selected tab element, and
a secondary display area including a plurality of horizontal navigation bars, the plurality of horizontal navigation bars being arranged in a listing order based on contextual relevance to the selected tab element, and the plurality of horizontal navigation bars including a second plurality of graphical elements;
detect a selection of a graphical element of the first and second pluralities of graphical elements; and
update, in response to the selection, the presentation of the control interface by:
updating the first plurality of graphical elements of the primary display region, and
updating the listing order and the second plurality of graphical elements of the plurality of horizontal navigation bars.

12. The display device of claim 11, wherein the processor is further configured to monitor the usage of the display device by:
identifying titles of content accessed by a user using the control interface;
identifying categories of content associated with accessed content titles; and
monitoring a presentation time of the accessed content.

13. The display device of claim 11, wherein the processor is further configured to monitor the usage of the display device by:
monitoring media content accessed using the display device;
monitoring games played using the display device; and
monitoring third-party applications accessed using the display device.

14. The display device of claim 11, wherein
the first plurality of graphical elements correspond to respective content accessible by the display device, and
wherein the processor is further configured to select the first plurality of graphical elements such that the respective content relates to a current content most recently presented by the display device.

15. The display device of claim 11, wherein the listing order of the plurality of horizontal navigation bars is selected such that the second plurality of graphical elements in higher horizontal navigation bars are more contextually related to a current usage of the display device.

16. The display device of claim 11, wherein
the contextual relevance of a navigation bar from the plurality of navigation bars include at least one selected from the group of contextual content, usage-based content, user preference content, social media driven content, and curated content,
contextual content is more contextually relevant than usage-based content, which is more contextually relevant that user preference content, and
user preference content is more contextually relevant than social media driven content, which is more contextually relevant than curated content.

17. The display device of claim 11, wherein the processor is further configured to detect the selection of the graphical element by:
detecting navigation within the secondary display area; and
detecting a selection of a graphical element from among the respective second plurality of graphical elements.

18. The display device of claim 11, wherein the processor is further configured to update the presentation of the control interface by updating a current content presented by the display device to a content corresponding to the selected graphical element.

19. The display device of claim 11, wherein the processor is further configured to update the presentation of the control interface by changing a category type for populating each of the plurality of horizontal navigation bars.

20. The display device of claim 11, wherein the processor is further configured to create tables for content tiles and tile elements based on monitored usage and content available to the display device.
